(19) United States
(12) Patent Application Publication
(10) Pub. No.: US 2014/0265316 A1
(43) Pub. Date: Sep. 18, 2014

(54) LOCKING CATCH AND LATCH FOR QUICK CONNECT HYDRAULIC COUPLER

(71) Applicant: Kevin Mullin, Pittsburgh, PA (US)

(72) Inventor: Kevin Mullin, Pittsburgh, PA (US)

(21) Appl. No.: 14/181,764

(22) Filed: Feb. 17, 2014

Related U.S. Application Data
(60) Provisional application No. 61/789,033, filed on Mar. 15, 2013.

(51) Int. Cl. F16L 21/08

(52) U.S. Cl. CPC F16L 21/08
USPC 285/315

(57) ABSTRACT

A double locking mechanism for male and female fluid coupling members that can lock the moveable sleeve on the female member in the open position to facilitate coupling with the male member, or in the closed position to prevent male member from disconnecting from female member. A catch is integrated with the nonmoveable portion of the female coupler and a latch is attached to or integrally formed with the female member's movable sleeve. The movable sleeve is retracted and rotated such that the latch engages the catch to lock the sleeve in an open position. When the male member is fully engaged with the female member, the movable sleeve is rotated so that the latch engages the catch to lock the sleeve in a closed position.

### CROSS-REFERENCE TO RELATED APPLICATIONS

This application is a Non-provisional Application that claims the benefit of U.S. Provisional Application Ser. No. 61/789,033, titled LOCKING CATCH AND LATCH FOR QUICK CONNECT HYDRAULIC COUPLER, filed Mar. 15, 2013, which is incorporated by reference herein.

### BACKGROUND OF THE INVENTION

The present invention relates to quick connect hydraulic couplers. These hydraulic couplers are used in many industries for connecting hydraulic fluid lines. Many are used in the transportation industry to connect trailers to their tractors or hydraulic equipment in the field. The quick connect hydraulic coupler products currently available are very useful in joining hydraulic lines together. There are, however, a number of problems associated with their use. For example, there are many times that there is pressure in the lines from the hydraulic fluid which causes difficulty in connecting the lines. Also, the design of the female coupler makes the coupling task very difficult, especially in cold or wet weather. In most couplers, to allow the male coupler to enter the female coupler the outer sleeve on the female coupler must be pulled back all the way to allow the ball bearings to slide outwardly so that the male coupler can fully enter. The springs in the sleeve exert an outward pressure that keeps the sleeve in a locked position. These springs are very strong to maintain the sleeve on the female coupler in the closed position. Thus, pulling the sleeve against the springs is very difficult. Making this task more difficult is that one needs one hand to pull the sleeve in the opposite direction from the mating coupler. Because of the location of these lines it is often times very difficult for the operator to hold the coupling flange backwards while attempting to align the male fitting into the coupler. Additionally, the grip on the fitting is difficult if the fitting is wet or oily and there is residual pressure in the line. This often necessitates and additional set of hands.

Once the male fitting is fully engaged with the female, the sleeve needs to be released to allow the ball bearings to ride over the ‘head’ of the male fitting so that the sleeve can fully move back in place locking the two lines together. If the sleeve in not released before the person pushing the two lines together stops applying force then the male will slip out.

Another flaw with the female coupler is that it is difficult to clean. Over time debris invades the inside of the female coupler. Rust, dirt, fluid and other substances tend to get under the sleeve and around the ball bearings. The smallest obstruction in and around any of the moving parts prevents the female coupler from working properly. Cleaning the female coupler is more difficult than it should be. The operator must pull the sleeve all the way back into the “open” position. Once that is done a tool can be used to clean out any dirt or obstructions. To accomplish this one must use one hand to pull the sleeve back and old it there while it is being cleaned. Even a person with great hand strength eventually loses grip and tires quickly.

Once the lines are successfully combined and locked, the hydraulic fluid or air is free to cycle through the coupling. However, while pressure from the fluid or air is cycling through or has been through and the machines turned off, it takes very little for the lines to accidentally disconnect. The female sleeve is typically only in its locked position and kept that way by the springs in the female coupling. There is nothing else or any kind of pressure that maintains the coupling in a locked or closed position. If the female sleeve were to be bumped in any way that slides it back, even a small amount, the lines will disconnect. Most conventional couplers have a locking ball in both the male and female ends. This typically prevents fluid/air from being released. However, even with this, it can be an unnecessary hassle and, at times, can be dangerous to the equipment and the operator.

### DESCRIPTION OF THE INVENTION

The present invention overcomes the problems described above by using a novel double locking means mounted to the movable sleeve on the female coupler. On the nonmoveable portion of the coupler is a catch mounted at the terminus of female sleeve's movement from the receiving end coupler. In a preferred embodiment of the invention, the double locking means comprises a latch configured as a “double L” which is attached to or integrally formed with the female's movable sleeve. The double locking means is position on the sleeve so to engage the catch on its top side by the bottom of the double L as the sleeve is rotated in its fully retracted position. When the male fitting is engagedly positioned into the female, the sleeve is rotated of the catch to permit the sleeve to fully encompass the mating portion of the male fitting. The sleeve can be then optionally rotated so that the top of the double L mates with the bottom of the catch. When so located, the sleeve is prevented from axially moving away from engaged couplings preventing a disconnection of the two members.

Accordingly, the invention provides novel means that can lock the sleeve open and also lock the sleeve closed. When the sleeve is locked closed, the only way to open it is to turn the sleeve out of engagement. If the sleeve is bumped by any obstacle it will not open and accidentally disconnect. It needs to be manually rotated in the unlocking direction. Once rotated, an operator can pull back on the sleeve to either release the male coupler or prepare it to accept the male coupler. This has the potential for dramatically reducing accidental disconnects in all uses of quick connect hydraulic fluid and air couplers.

Placing the female couple in the locked open state and keeping it there is now simple and hands free. Once the sleeve is pulled all the way back, which allows the ball bearings to slide out, the user simply turns the sleeve about to engage the catch. The sleeve will stay in the locked open position. With the female sleeve in the locked open position, it facilitates simpler cleaning and maintenance of female coupler. Without having to hold the sleeve in the retracted position, an operator can use both hands to work all the small areas.

A primary benefit of the double locking sleeve is that it simplifies and makes it easier to join the quick connect hydraulic/air male and female couplers. There is no longer a need for another set of hands to hold the sleeve back. The operator can use both hands to align the male and female couplers and push them together. A better understanding of the invention's embodiments can be gleaned from the drawings of the preferred embodiments below.

### DRAWINGS

FIG. 1 is a perspective view of the male portion of a coupling of the present invention;

FIG. 2 is a perspective view of the female coupling with its latch and catch in its normal position;

FIG. 3 is a perspective view of the female coupling of the present invention showing the sleeve in its retracted position with the double L latch engaging the catch to facilitate connection;

FIG. 3A is a side view of the female coupling of FIG. 3;

FIG. 4 is an elevation of the male and female engaged with the latch engaging the bottom side of the catch to prevent the sleeve from moving out of engagement position, and

FIG. 5 is an elevation of another embodiment of the invention.

### DETAILED DESCRIPTION OF THE INVENTION

Referring to FIG. 1 a perspective view of a male coupler 10 is shown. Coupler 10 comprises insertion end 11 having a recessed ball valve 12 which prevents back flow of the hydraulic fluid (air or fluid). An engaging flange 13 provides a means for internal engagement with the bearing in the female coupling 20.

Referring to FIG. 2, a perspective view of the female coupling 20 shows a movable sleeve 22. Movable sleeve 22 is biased by a conventional internal spring (not shown) towards coupling opening 23. Opening 23 of coupling 20 is the engagement end for male coupling 10 and includes an annular ring of bearing 24 which are held in place by sleeve 22. The bearings 24 are positioned to engage the outer surface of male coupler 10 between its end and flange 13 when inserted into opening 23. In the back center of opening 23 is a valve 26 biased towards the opening to engage and open valve 12 in the male coupler. When both the male and females coupling members are fully engaged the valves 12 and 26 to open the flow of fluid through the coupling members.

Sleeve 22 includes latch 25. Latch 25 comprises a “double L” configuration with leg 29 thereof having engagement surfaces 29a and 29b. Engagement surfaces 29a and 29b provide for the engagement with respective surfaces 27a and 27b of catch 27. Catch 27 is positioned on the outer surface of female coupling 20 at a location distance preferably equal to the width distance 28 between surfaces 29a and 29 which is and removed from the terminus of movement of sleeve 22 as it is move away from end 23. The distance 28 is preferably at least equal to the width “a” of catch 27.

Referring to FIGS. 3 and 3A, sleeve 22 is shown fully retracted on female coupling. Surface 29a of latch 25 is designed to rest on outer edge 27a of catch 27. When sleeve 22 is retracted its full extent and edge 29a of latch 25 is engaging side 27a of the catch 27, the female coupling is fully open for cleaning and for insertion of male 10. It also permits the operator to insert male 10 into the female without force. Rotating sleeve 22 disengages the sleeve from catch 27 and permits the sleeve to move to full engagement with the male 10 by reason of its biasing spring. By rotating sleeve 22, the outer edge 29b of latch 25 can engage the inner edge 27b of catch 27 there preventing unintentional linear movement of the sleeve as depicted in FIG. 4. It is clear that design modifications can be made to both the latch and catch within the scope of the appended claims. The preferred embodiment provide an extremely effective and easily used safety feature.

The use of the catch 27 and latch 25, coupling of hydraulic fluid lines is greatly facilitated with a corresponding benefit that once couple the catch and latch prevents lateral movement of the sleeve, thus preventing unintended disengagement of the coupling. In its retracted state, the coupling of the two ends is greatly facilitated.

Referring to FIG. 5, another embodiment of the invention is shown. Latch 40 comprises an “L” or “J” shaped cut or slot 41 through sleeve 42. The inner length of slot is substantially equal to the length of retraction of sleeve 42. The width of slot 41 is slightly larger than the width of the catch to be accommodated. A catch 47 is positioned on the female coupling 50 immediately adjacent to and abutting the inner edge 43 of sleeve 42. Catch 47 can comprise a small pin which can be placed in a small opening and welded/brazed in place on the coupling 50. A plurality of catches 47 can be positioned around the circumference of female coupling as well as an equal number of latches 40 juxtaposed to a corresponding catch 47. In either embodiment, only slight rotation and a withdrawal of the sleeve from the opening will permit retention of the latch or latches in its associated catch.

While presently preferred embodiments of the invention has been shown and described, the invention may be otherwise embodied within the scope of the appended claims.

What is claimed is:

1. A fluid coupling means having a male member and a female member, said female member having an annular receiving end for receiving a male member having annular end with an annular flange, said female member receiving end including a plurality of annular bearings adapted to be engaged by the annular flange of said male member, an annular sleeve slideably mounted on the exterior of the female member and having a biasing means biasing said flange to the receiving end of said female member, a catch on the exterior of said female member juxtaposed and spaced away from the sleeve when said sleeve is positioned fully away from said receiving end and a latch mounted to said sleeve to engage said catch when said sleeve is fully retracted for insertion of the male annular flange and to engage said catch when the male annular flange is fully engaged with said sleeve.

2. A fluid coupling as set forth in claim 1 wherein said latch is in the form an inverted “L” and is adapted to engage said catch.

3. A fluid coupling as set forth in claim 1 wherein said latch is the form of a “T” and is adapted to engage said catch.

4. A fluid coupling as set forth in claim 1 wherein said catch comprises a post mounted adjacent said sleeve.

5. A fluid coupling means having a male member and a female member, said female member having an annular receiving end for receiving a male member having annular end with an annular flange, said female member receiving end including a plurality of annular bearings adapted to be engaged by the annular flange of said male member, an annular sleeve slideably mounted on the exterior of the female member and having a biasing means biasing said annular flange to the receiving end of said female member, a catch on the exterior of said female member juxtaposed to the sleeve when said sleeve is positioned in its normal, un-retracted position and a latch formed as an axial slot in said sleeve extending from the inner edge of said sleeve an axial length equal to the movement of said sleeve and having a circumferential offset at its base to engage said catch when said sleeve is fully retracted for insertion of the male annular flange and to engage said catch when the male annular flange is fully engaged with said sleeve.

6. A coupling as set forth in claim 2 wherein said slot and offset is in the form of “J”.

7. A coupling as set forth in claim 2 wherein said slot and offset is in the form of “L”.

8. A coupling as set forth in claim 2 wherein said slot and offset is in the form of an inverted “T”.

9. A coupling as set forth in claim 2 wherein said slot and offset is in the form of “E”.
